(19) United States
(12) Patent Application Publication
(10) Pub. No.: US 2008/0201435 A1
(43) Pub. Date: Aug. 21, 2008

(54) METHOD AND SYSTEM FOR ORDERING ADDRESSEES IN ADDRESS FIELDS

(76) Inventors: Oded Dubovsky, Haifa (IL); Itzhack Goldberg, Hadera (IL); Ido Levy, Kiryat Mozkin (IL); Maya Shiran, Haifa (IL)

Correspondence Address: Stephen C. Kaufman;IBM CORPORATION, Intellectual Property Law Dept., P.O. Box 218, Yorktown Heights, NY, 10598, US

(21) Appl. No.: 11/676,514

(22) Filed: Feb. 20, 2007

(51) Int. Cl. G06F 13/00; G06F 15/16

(52) U.S. Cl. 709/206; 711/108

(57) ABSTRACT

A method and system for ordering addressees in address fields (141-143) is provided. The method includes entering a plurality of addresses in an address field (141-143) of a message; selecting an ordering policy (134); and ordering (132) the addresses in the address field (141-143) in accordance with the selected ordering policy. The ordering policy (134) may include general ordering policies such as alphabetical ordering, or flattering ordering in which the recipient's address is at the head of the address field. Weightings for individual addressees may be defined. Weightings may be absolute and/or relative to other addressees. An ordering policy (134) may be selected for each of the address fields “To:”, “Cc:”, and “Bcc:”.

### FIELD OF THE INVENTION

This invention relates to the field of ordering addressees in address fields. In particular, the invention relates to ordering addressees in address fields in messaging applications.

### BACKGROUND OF THE INVENTION

In messaging applications a message can be sent to more than one recipient by entering multiple recipient addresses in an address field. For example, such messaging applications may include email applications, scheduling applications in which invitation messages are sent, etc. In email applications, there are address fields for the main recipients (the “To:” field), for copy recipients (the “Cc:” field), and for blind copy recipients (the “Bcc:” field). Other fields may also be used, for example, group blind copy recipients (the “Bccg:” field) in which only other recipients in the same group can see each other in the field address list.

A user may enter multiple addresses into the various address fields without paying attention to the order of the addresses. However, the order may be important to the recipients. For example, in a business environment, the management hierarchy may need to be adhered to, to avoid giving unwitting offence.

In conventional email applications, if a “Reply to All” function is used when responding to a received email, all the recipients of the received email are added to the “Cc:” field. However, the email client application does not enable the user to arrange the order of the addressees in the “Cc:” field according to on-line or off-line preferences. Often the order of the addresses in the field does not fit the importance of the recipients and hence, the user needs to edit the lists and change the order manually.

### SUMMARY OF THE INVENTION

According to a first aspect of the present invention there is provided a method for ordering addressees in address fields, comprising: entering a plurality of addresses in an address field of a message; selecting an ordering policy; and ordering the addresses in the address field in accordance with the selected ordering policy.

According to a second aspect of the present invention there is provided a computer program product stored on a computer readable storage medium for ordering addressees in an address fields, comprising computer readable program code means for performing the steps of: determining a plurality of addresses in an address field of a message; determining a selected ordering policy; and ordering the addresses in the address field in accordance with the selected ordering policy.

According to a third aspect of the present invention there is provided a messaging system comprising: means for selecting an ordering policy to be applied to a plurality of addresses in an address field of a message; means for ordering the addresses in the address field in accordance with the selected ordering policy.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1A is a block diagram of a messaging system in which the present invention may be implemented;

FIG. 1B is a block diagram of a messaging system in accordance with the present invention;

FIG. 2 is a block diagram of a computer system in which the present invention may be implemented;

FIGS. 3A and 3B are representations of a graphical user interface of a messaging application in accordance with an aspect of the present invention;

FIG. 4 is a representation of a graphical user interface of a messaging application in accordance with an aspect of the present invention;

FIG. 5 is a representation of a graphical user interface of a messaging application in accordance with an aspect of the present invention; and

FIG. 6 is a flow diagram of a method in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

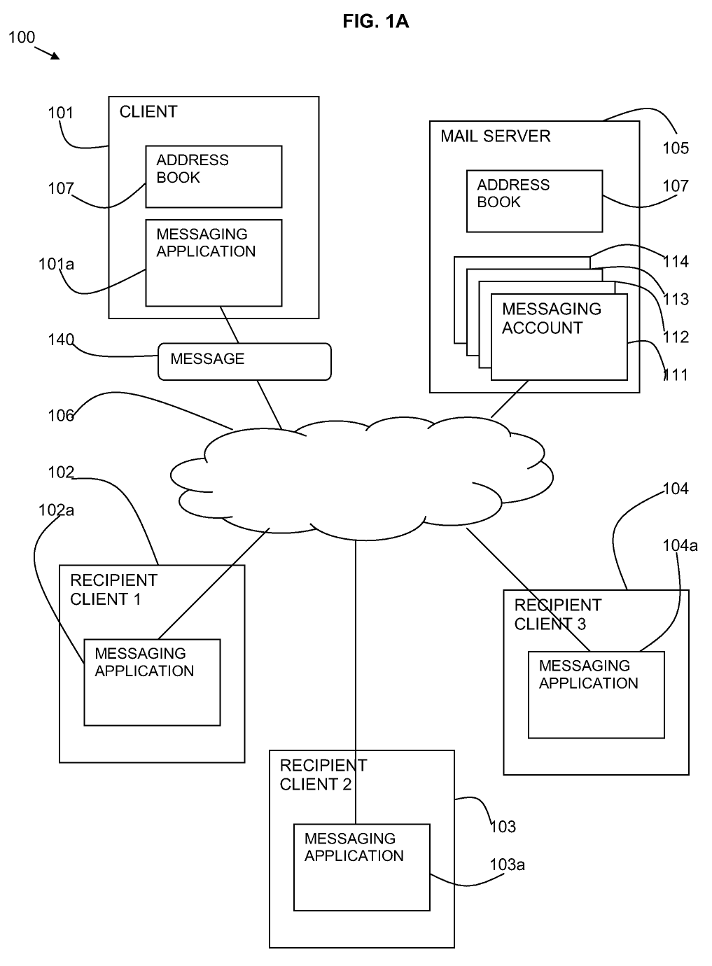

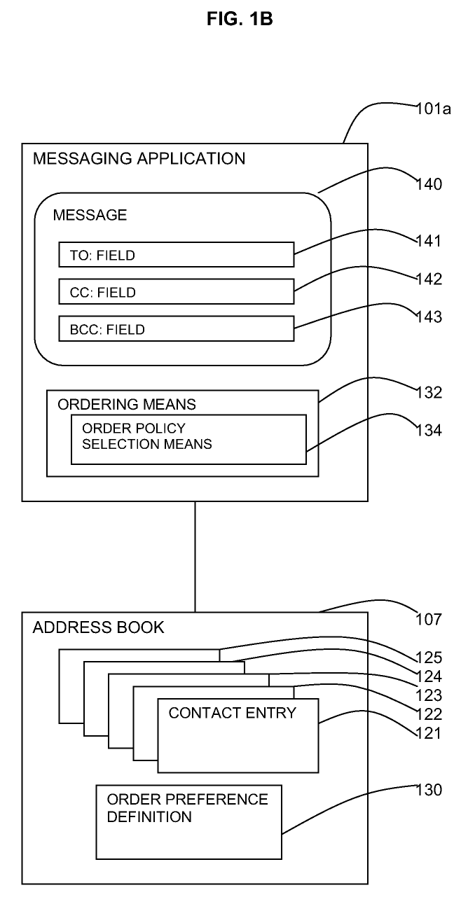

An improved messaging system is provided in which a single message can be sent to multiple recipients. Referring to FIG. 1A, a messaging system 100 includes a first client 101 with a messaging application 101a. The first client 101 is the originator of a message 140 which is intended for multiple recipient clients 102, 103, 104 each with its own messaging application 102a, 103a, 104a. Each client 101-104 may send and receive messages.

Each messaging application 101a-104a at each of the clients 101-104 has a designated mail server 105. Each client 101-104 has its own messaging account 111-114 which are actually stored on the server 105 with the clients 101-104 having local replicas on their machines. The information in these messaging accounts 111-114 resides on the server 105, but the messaging accounts are “owned” by the clients 101-104.

In FIG. 1A, a single mail server 105 is shown; however, different clients 101-104 may use different mail servers. The clients 101-104 and mail server(s) 105 are connected by a network 106, such as the Internet.

A client 101-104 may have an address book 107 containing all the addresses of contacts to whom a client sends messages. The address book 107 may be coupled to the client messaging application 101a-104a, it may be provided on the client system or it may be provided remotely, for example on a mail server 105 or other location accessible via the network 106.

A messaging system is described in which a user can set the order of multiple addresses in address fields according to a preference policy. Referring to FIG. 1B, a messaging application 101a is shown. When a new message 140 is created it includes address fields, most often fields for “To;” 141, “Cc:” 142, and “Bcc:” 143.

The messaging application 101a includes an ordering means 132 which orders addresses in each address field 141, 142, 143 of a generated message 140. The ordering means 132 may include a selection means 134 for selecting one of various options of order policies.

The order policies may be generally applicable to any list regardless of the addressees in the list. An example of a generally applicable order policy is an alphabetical sort, or a flattering sort with each recipient appearing at the head of the list in his/her message.

The order policies may alternatively be specific to a given list. An example for a given list is to maintain the received order for that list, to retrieve defined order preferences for the set of addressees in a list, or to retrieve defined order preferences for individual addressees in a list.

A combination of order policies may also be applied. For example, alphabetical sort and flattering sort may be applied with the recipient at the head of the address list and all the remaining addressees sorted alphabetically.

The messaging application 101a may be coupled to an address book 107. The address book 107 includes entries 121-125, one for each contact. In addition to the conventional contact information stored in the entries 121-125 of an address book 107, an entry 121-125 may include a defined order preference 130 for the contact. The form of the defined order preference 130 may vary depending on the implementation, for example, it may be an absolute value or a relative value compared to other entries 121-125, or a combination of absolute value and relative value.

Alternatively, the defined order preferences 130 for contacts may be stored separately from the address book 107. In one embodiment, the defined order preferences 130 may be stored remotely and accessed by the ordering means 132 via a network.

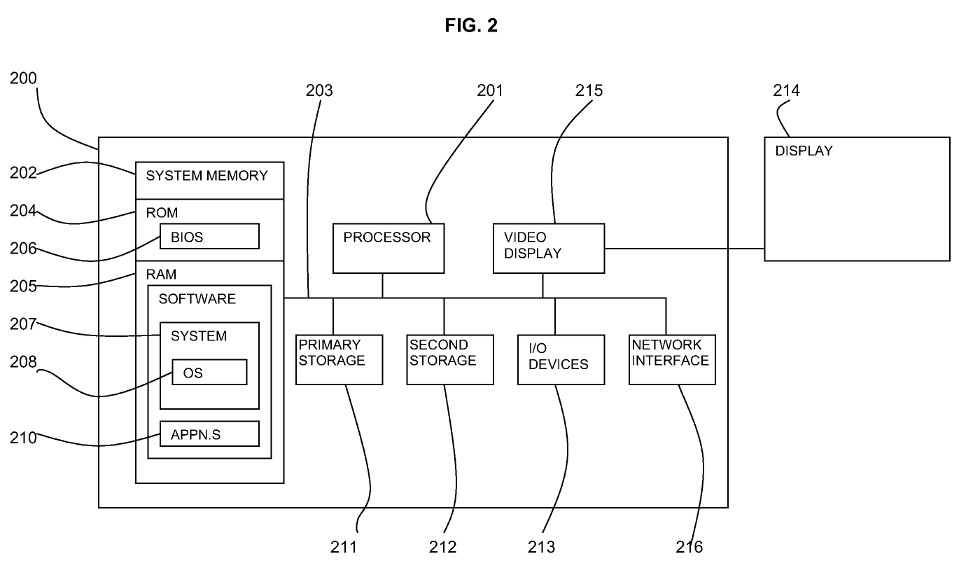

Referring to FIG. 2, an exemplary system for implementing client and servers may take the form of a data processing system 200 suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

The defined order preferences for an addressee may take various different forms. Assuming most users will not want to spend time on building preference-lists and updating them, a default setting may be to leave the order of addressee lists intact such that the lists are backward compatible with earlier messages.

Different policies may be set for the different address fields of the “To:”, “Cc:” and “Bcc:” lists.

The order policy may be generally applicable to any list regardless of the addressees in the list. For example, such general ordering policies may include:
1) An alphabetical sort of the list of addressees. In this case, if chosen the addressees are re-ordered into an alphabetical list. This has the benefit of displaying no preferences or bias between the addressees. The list may include a tag to indicate the alphabetical sort to demonstrate unbiased delivery.
2) A flattering sort of the list of addressees. In this policy, each recipient receives the message with his/her name at the front of the addressee list whether it is the “To:”, “Cc:”, or “Bcc:”. The lists are identical except for the fact that each user is “flattered” with being the first in the lists. A sub-policy for sorting the addresses after the recipient's address may be used, for example an alphabetical sort.

In a flattering sort in which each recipient appears at the head of the list in his/her message, the message includes a flag indicating that it has a flattered sort. Support at the receiving mail client, notes the flag and sets the order in the received message accordingly.

The order policies may alternatively be specific to a given list.
1) A set of addressees may have been previously ordered by the user and saved for use when the same set of addressees or a sub-set of the addresses is entered. Means may be provided to set the order off-line and automatically to set the order for the user once sending a message to the addressees or a sub-set of the addressees.
2) A weighted sort of the list of addressees. In this policy, the user can set the weights off-line or on-line when sending the message. The user can assign weights of importance to each of the addresses. The weight can be either absolute or relative.

In an absolute weighting, a user can allocate the highest importance to an addressee by assigning it the relative infinite-symbol (to be defined), or by assigning to it the highest weight in a range (for example, 1 to 1000). Unassigned addresses are allotted a default absolute weight.

In a relative weighting, the importance of a given addressee compared to another addressee is defined. For example, Smith=Brown+1, etc. Assuming P1 has a absolute weigh=n (assume this is the default weigh), then if P2 is defined as relative to P1, for example: P2=P1+1, then P2's weight is set to n+1. In this way, the relative weighting is based on the absolute weighting. Relative weights help set the importance of the addressees in a more intuitive way than using numbers explicitly as in a solely absolute weighting method.

The preferences can also be applied to mailing-lists of course. Considering mailing lists as a single addressee enables them to be treated the same and to enforce different policies in the same manner. Here instead of thinking of all the addressees as being in the same level, the mailing lists can be thought of as the higher level and the addressees inside each mailing list as a sub-level, with the policy enforced separately on each level.

For example, if there are a number of mailing lists and the policy is to sort alphabetically; the addressees in each mailing list should be sorted alphabetically and the order of the mailing lists is also shown according to their alphabetical sort.

A mailing list may be stored with X, Y, Z members (in this order), and a predefined policy is to order the members: Y, Z, X. Then once a user chooses this mailing list in an address field, the policy automatically sorts this out, so eventually a user sees Y, Z, X on the address list. Since each individual mail address within a mailing list may have a weight, then when multiple mailing lists are chosen, the ordering means would also set the total order between the individual addresses, as expected.

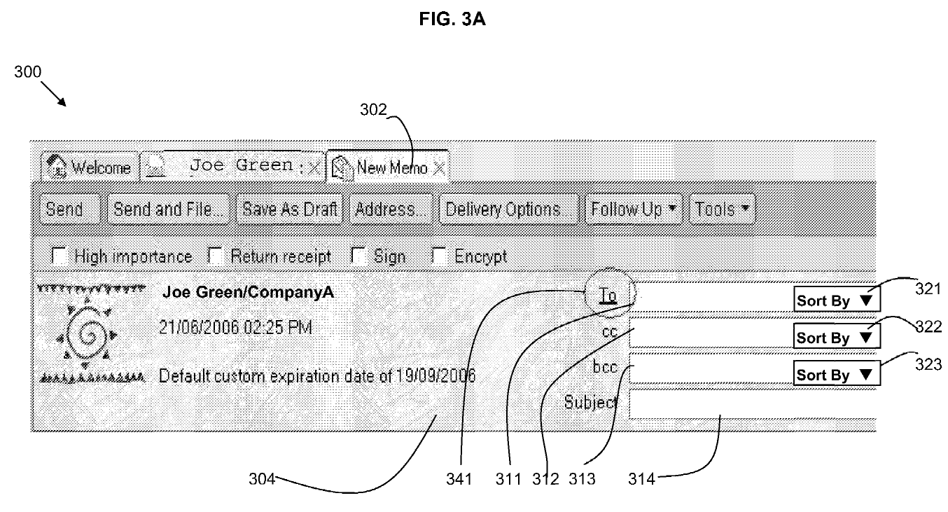

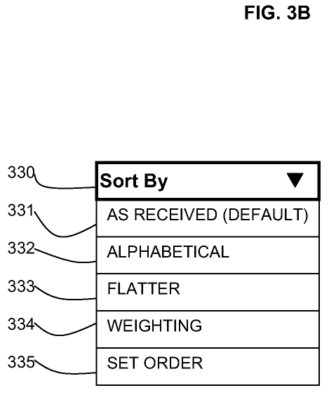

Referring to FIGS. 3A and 3B, a first example embodiment is described. A graphical user interface (GUI) 300 for a messaging application is shown. A new message option 302 provides a template 304 for a new message. The template 304 includes address fields 311, 312, 313 for “To:” addresses 311, “Cc:” addresses 312, and “Bcc:” addresses 313. A field 314 is also usually provided for the subject of the message.

In accordance with one embodiment of the described system, each of the address fields 311, 312, 313 has a selection menu 321, 322, 323 for selecting an ordering policy for the address field. This feature can be enabled, or disabled by the user.

FIG. 3B shows an example drop down menu 330 of ordering policy options, as follows:

“As received” 331—The order of the addresses in a received message to which this message is a response is used.
“Alphabetical” 332—An alphabetical sort is applied to the input addresses.
“Flatter” 333—The recipient of a message has his/her address shown at the head of the list.
“Weighting” 334—This is set for individual addresses.
“Set order” 334—This may to used if an order for a set of addresses has been saved. The address set may be recognised and the order applied if this option is selected.

One of the order options can be selected as the default, in this example, the order as received option 331 is selected.

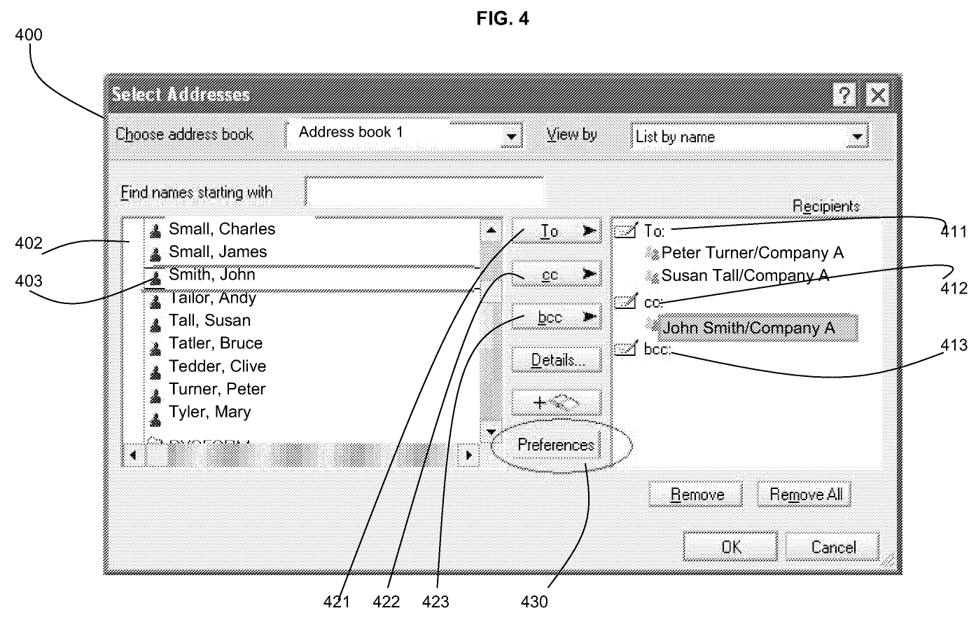

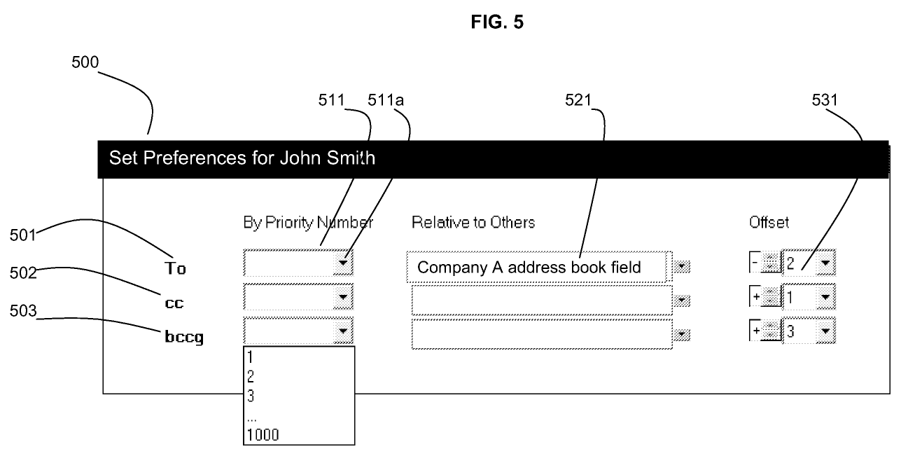

Referring to FIGS. 4 and 5, a second example embodiment is described. This embodiment may be used in addition to the first example embodiment shown in FIGS. 3A and 3B. The address field header 341 may be selected to set preferences for addressees by opening the GUI for an address book 400.

A GUI for an address book 400 may be provided which lists 402 all the contact entries. An entry 403 can be selected and it can be added to address lists 411, 412, 413 by selection of corresponding address list buttons 421, 422, 423.

An additional selection button 430 is provided for setting preferences for the order of a contact in address lists 411, 412, 413. FIG. 5 shows a preferences panel 500 for a contact.

In the preference panel 500, each address field 501, 502, 503 has options for ordering of the contact. Taking the “To:” address field 501, there is an option to apply an absolute order by priority number 511 by selecting a number from a drop down menu 511a. In this example, the numbers run from 1 to 1000.

There is also an alternative option for relative ordering. A field 521 is provided in which to select an address relative to which the ordering of the contact is to be applied. An offset option 531 can then be selected indicating whether this contact should be before or after the selected relative address.

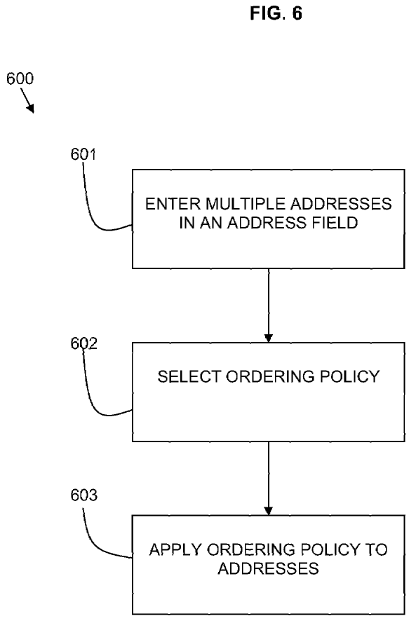

Referring to FIG. 6, a flow diagram is shown of a method 600 of ordering addressees in an address field. Multiple addresses are entered into an address field 601. This may be by individually entering each address, or by entering a predefined group of addressees into an address field. An ordering policy is selected 602. The ordering policy is applied to the addresses in the address field 603.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for ordering addressees in address fields, comprising:
entering a plurality of addresses in an address field of a message;
selecting an ordering policy; and
ordering the addresses in the address field in accordance with the selected ordering policy.

2. The method as claimed in claim 1, wherein an ordering policy is selected for each address field.

3. The method as claimed in claim 1, wherein an ordering policy is a general ordering policy that can be applied to any list of addresses.

4. The method as claimed in claim 3, wherein a general ordering policy is alphabetically sorting the addresses.

5. The method as claimed in claim 3, wherein a general ordering policy places the address of the recipient of a message at the head of the other addresses in the address field.

6. The method as claimed in claim 3, wherein a general ordering policy is to use an order of addresses as given in a received message.

7. The method as claimed in claim 1, wherein an ordering policy is a defined order for a given set of addresses, or a sub-set of the addresses.

8. The method as claimed in claim 1, wherein an ordering policy applies previously defined absolute weightings of addressees.

9. The method as claimed in claim 1, wherein an ordering policy applies previously defined relative weightings, in which an offset is defined for an addressee with respect to another addressee.

10. The method as claimed in claim 8, wherein addressees with unassigned weightings are assigned a default weighting.

11. The method as claimed in claim 1, wherein an ordering policy is set as the default ordering policy.

12. The method as claimed in claim 1, wherein an address in an address field is a mailing list containing multiple recipients, and an ordering policy is applied at the level of the mailing list address in the address field, and at the level of the addresses within the mailing list.

13. A messaging system comprising:
means for selecting an ordering policy to be applied to a plurality of addresses in an address field of a message;
means for ordering the addresses in the address field in accordance with the selected ordering policy.

14. The messaging system as claimed in claim 13, wherein means are provided for selecting an ordering policy for each one of multiple address fields.

15. The messaging system as claimed in claim 13, wherein an ordering policy is a general ordering policy that can be applied to any list of addresses.

16. The messaging system as claimed in claim 13, including means for defining an order for a set of addresses.

17. The messaging system as claimed in claim 13, including means for defining absolute or relative weightings of addressees.

18. The messaging system as claimed in claim 13, wherein a message includes a flag indicating a defined order, and a receiving mail client orders the addresses in accordance with the flag indication.

19. The messaging system as claimed in claim 18, wherein the flag indicates a flattering order and the receiving mail client moves the recipient address to the head of the list.

20. A computer program product stored on a computer readable storage medium for ordering addressees in an address fields, comprising computer readable program code means for performing the steps of:
determining a plurality of addresses in an address field of a message;
determining a selected ordering policy; and
ordering the addresses in the address field in accordance with the selected ordering policy.
